(19) United States
(12) Patent Application Publication
(10) Pub. No.: US 2004/0207569 A1
(43) Pub. Date: Oct. 21, 2004

(54) Dual-display panel module with a shared ASIC chip

(75) Inventors: Shyuan-Jeng Ho, Hsinchu City (TW); Ying-Chieh Chen, Nantou (TW)

Correspondence Address: LIU & LIU LLP, 811 WEST SEVENTH STREET, SUITE 1100, LOS ANGELES, CA, 90017, US

(73) Assignee: Toppoly Optoelectronics Corp.

(21) Appl. No.: 10/828,761

(22) Filed: Apr. 20, 2004

(30) Foreign Application Priority Data
Apr. 21, 2003 (TW) 92206260

(51) Int. Cl. G09G 5/00

(52) U.S. Cl. 345/1.1

(57) ABSTRACT

A dual-display panel module has a shared ASIC chip. A primary-display panel module provides obverse-side image display, a secondary-display panel module provides reverse-side image display, a connector electrically connects the primary-display panel and second-display panel, and a driver operatively is coupled to the primary display module and secondary display module, wherein the driver is supported in electrical connections the primary display module and the secondary display modules via the connector.

### BACKGROUND OF THE INVENTION

1. Field of the Invention

The invention relates to a dual-display device and more particularly to a dual-display panel module with one ASIC chip shared between a primary-display panel module and a secondary-display panel module.

2. Description of the Related Art

In current flat display technology, dual-display LCDs have been developed for displaying images and characters on two LCD panels. Dual-display technology is applied mainly in small-size LCDs for folding mobile phones and handheld computers. In general, a dual-display panel module is composed of a primary-display panel module, a secondary-display panel module and a backlight module shared therebetween, thus having the advantages of being thin and light and requiring fewer components.

FIG. 1 is a cross-section of a conventional dual-display panel module 1 used in an amorphous silicon (a-Si) TFT-LCD device, in which a primary-display panel module 1M has a larger display area and a secondary-display panel module 1S with a smaller display area. The dual-display panel module is composed of a primary-display panel module 1M for providing obverse-side image display, a secondary-display panel module 1S for providing reverse-side image display, and a backlight module 1L shared therebetween. The backlight module 1L includes a light source for the primary-display panel module 1M and the secondary-display panel module 1S, and a light source module 1L for improving light intensity and light uniformity.

The primary-display panel module 1M comprises a first LCD panel 10, an upper polarizer 12I and a lower polarizer 12II, in which the first LCD panel 10 is composed of an upper glass substrate, a lower glass substrate, and a liquid crystal layer. The secondary-display panel module 1S comprises a second LCD panel 20, an upper polarizer 22I and a lower polarizer 22II, in which the second LCD panel 20 is composed of an upper glass substrate, a lower glass substrate, and a liquid crystal layer. Adjacent to the first LCD panel 10, the light source module comprises a first prism 14I, a second prism 14II and a diffusion sheet 16. Adjacent to the second LCD panel 20, the light source module comprises a first prism 24I, a second prism 24II and a diffusion sheet 26. Also, the light source module comprises a light-guide plate (LGP) 18 and a transflective sheet 28 sandwiched between the two diffusion sheets 16 and 26.

In the chip scale package technology for the dual-display panel module, a chip-on-glass (COG) method is employed to assemble driving chips on the glass substrate. Thus, for the primary-display panel module 1M, a plurality of driving chips 30A is formed on an extended portion 11 of the glass substrate of the first LCD panel 10. Also, for the secondary-display panel module 1S, a plurality of driving chips 30B is formed on an extended portion 21 of the glass substrate of the second LCD panel 20. Moreover, an ASIC (Application Specific Integrated Circuit) chip and peripheral IC components can be connected to the panel through a COF (chip on flex) method. Thus, for the primary-display panel module 1M, a first ASIC chip 34A is connected to the glass substrate of the first LCD panel 10 through a first FPCB (flexible printed circuit board) 32A. For the secondary-display panel module 1S, a second ASIC chip 34B is connected to the glass substrate of the second LCD panel 20 through a second FPCB (flexible printed circuit board) 32B.

FIG. 2 is a cross-section of a conventional dual-display panel module 100 used in a low-temperature polysilicon (LTPS) TFT-LCD device, in which a primary-display panel module 100M and a secondary-display panel module 100S have identical display areas. The dual-display panel module 100 is composed of a primary-display panel module 100M for providing obverse-side image display, a secondary-display panel module 100S for providing reverse-side image display, and a backlight module 100L shared therebetween. The backlight module 100L includes a light source for the primary-display panel module 100M and the secondary-display panel module 100S, and a light source module 100L for improving light intensity and light uniformity. The dual-display panel module 100 shown in FIG. 2 is substantially similar to that of the dual-display panel module 1 shown in FIG. 1, except for the integration mode of the driving chips. Since the electron mobility is faster in the LTPS TFT-LCD, a part of the driving chips is integrated onto the glass substrate, which is favorable to reduce the required area and the amount of components on the PCB, and simplify the connecting wires between the driving chips and the panel electrodes.

In accordance with the dual-display panel modules shown in FIG. 1 and FIG. 2, the primary-display panel module and the secondary-display panel module are driven by the first ASIC chip 34A and the second ASIC chip 34B, respectively, and then connected to a system board (not shown). The requirement of the two ASIC chips 34A and 34B, however, requires considerable power consumption and increased production cost, and is unfavorable for reducing the component area and the amount of components on the FPCB.

### SUMMARY OF THE INVENTION

The present invention is directed to an electronic device incorporating a dual-display panel module that shares a driver by operatively coupling the driver to a common connection between two displays. The dual-display panel module includes a primary-display panel module and a secondary-display panel module. In one embodiment, the connector electrically connects to the respective ends of the primary and secondary display panels. Via this electrical connection, electrical traces are supported, which are electrically coupled to the outputs of the driver. The common driver facilitates control of both primary and secondary display panels. In one embodiment, the driver is an ASIC formed on the connector by a COF method. Accordingly, the present invention reduces power consumption, decreases production cost, and additionally reduces the component area and the amount of components on a FPCB.

### DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross-section view of a conventional dual-display panel module used in an amorphous silicon (a-Si) TFT-LCD device.

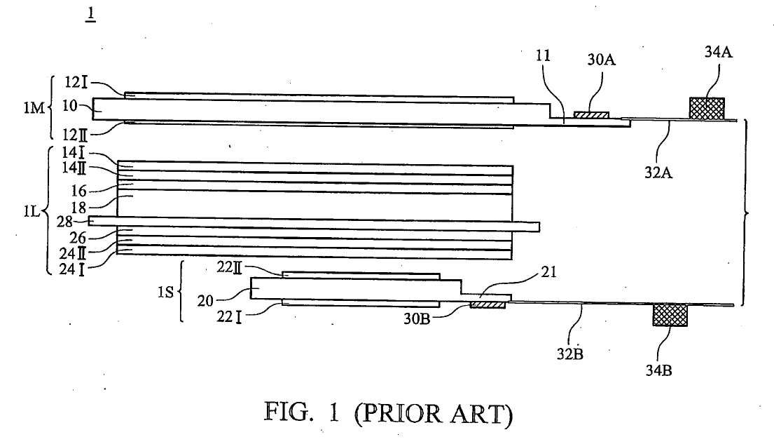

FIG. 2 is a cross-section view of a conventional dual-display panel module used in a low-temperature polysilicon (LTPS) TFT-LCD device.

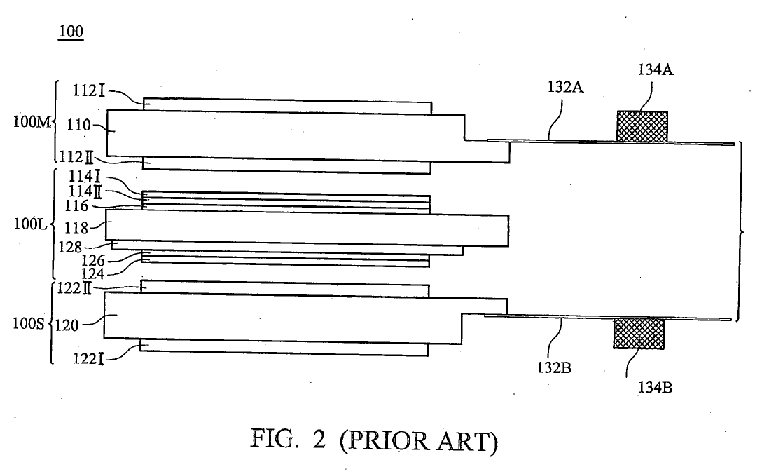

FIG. 3 is a schematic drawing of an electronic device in accordance with one embodiment of the present invention.

FIG. 4 is a cross-section view of a dual-display panel module according to the first embodiment of the present invention.

FIG. 5 is a cross-section view of a dual-display panel module according to the second embodiment of the present invention.

### DETAILED DESCRIPTION OF THE INVENTION

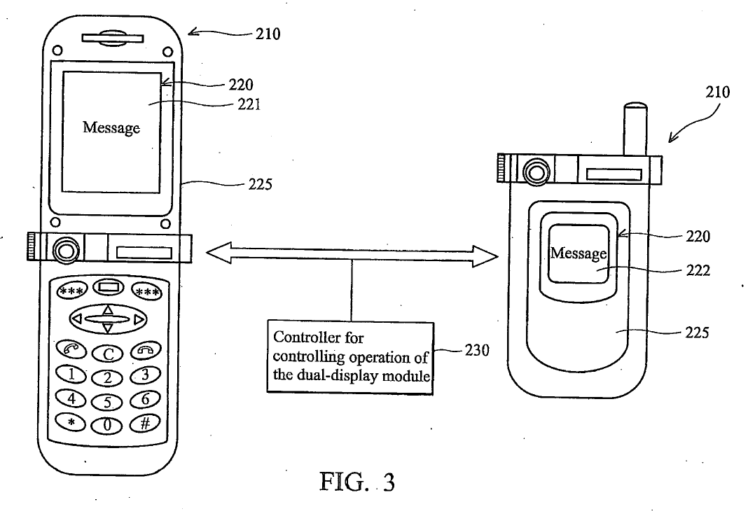

FIG. 3 is a schematic drawing of an electronic device 210 in accordance with one embodiment of the present invention. The electronic device 210 can be, for example, a mobile phone, a hand-held computer and others. A representative folding type mobile phone is shown in FIG. 3. Even so, the teachings may be further applied to any form of display device with the dual-display module. The electronic device 210 includes a dual-display module 220, a controller 230 for controlling operation of the dual-display module 220 and other components, such as keypad. Symbol 221 denotes the main display region, symbol 222 the auxiliary display region and symbol 225 the outer housing. According to signals (or data) from the controller 230, the message of the auxiliary display region 222 is displayed when the housing 225 is shut. Contrarily, the message of the main display region 221 is displayed when the housing 225 is open.

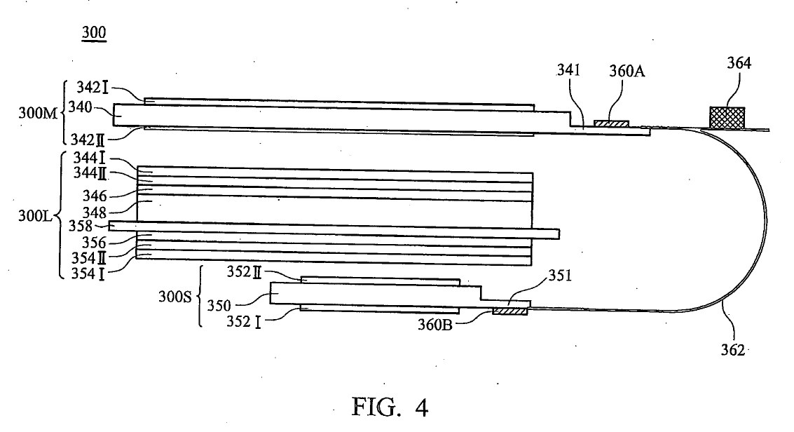

FIG. 4 is a cross-section view of a dual-display panel module 300 according to the first embodiment of the present invention. The dual-display panel module 300 comprises a primary-display panel module 300M, a secondary-display panel module 300S and a backlight module 300L shared between the two panel modules 300M and 300S. The primary-display panel module 300M is used to provide obverse-side image display, and the secondary-display panel module 300S is used to provide reverse-side image display. The backlight module 300L includes a light source and a lightsource module 300L. The light source provides the required light to the primary-display panel module 300M and the secondary-display panel module 300S. The lightsource module 300L is used to improve light intensity and light uniformity. The dual-display panel module 300 can be incorporated in a number of electronic devices, including flat display devices, such as an LCD device, a PDP device, and an OLED device, thus a display material layer may be a liquid crystal layer, a fluorescent layer, or an organic luminescent layer. Also, the area, corresponding location and functions of the primary-display panel module 300M and the secondary-display panel module 300S are not limited in the present invention.

FIG. 4 illustrates a dual-display panel module 300 used in an amorphous silicon (a-Si) TFT-LCD device, in which the display area of the primary-display panel module 300M is larger than that of the secondary-display panel module 300S. The primary-display panel module 300M comprises a first LCD panel 340, an upper polarizer 342I and a lower polarizer 342II. The first LCD panel 340 is composed of an upper glass substrate, a lower glass substrate and a liquid crystal layer, in which switching elements (such as a TFT array), pixel electrodes, LC alignment layers and color filters are formed. The secondary-display panel module 300S comprises a second LCD panel 350, an upper polarizer 352I, and a lower polarizer 352II. The second LCD panel 350 is composed of an upper glass substrate, a lower glass substrate and a liquid crystal layer, in which switching elements (such as a TFT array), pixel electrodes, LC alignment layers and color filters are completed.

The lightsource module 300L is disposed between the primary-display panel module 300M and the secondary-display panel module 300S. Adjacent to the lower polarizer 342II of the first LCD panel 340, the lightsource module 300L comprises a first prism 344I, a second prism 344II and a diffusion sheet 346. Also, adjacent to the lower polarizer 352II of the second LCD panel 350, the light-source module 300L comprises a first prism 354I, a second prism 354II and a diffusion sheet 356. Moreover, the light-source module 300L comprises a light-guide plate (LGP) 348 and a transflective sheet 358 sandwiched between the two diffusion sheets 346 and 356. The light-guide plate 348 is used to transform an incident light into an area light. The transflective sheet 358 is used to provide reflection from the bottom of the light-guide plate 348. The diffusion sheets 346 and 356 and the prisms 344 and 354 are used to improve the characteristics of the light emitted from the light-guide plate 348.

In the chip scale package technology for dual-display panel modules, a chip-on-glass (COG) method is employed to assemble driving chips on the glass substrate. Thus, for the primary-display panel module 300M, a plurality of driving chips 360A is formed on an extended portion 341 of the glass substrate of the first LCD panel 340. Also, for the secondary-display panel module 300S, a plurality of driving chips 360B is formed on an extended portion 351 of the glass substrate of the second LCD panel 350.

Moreover, a driver, such as an ASIC (Application Specific Integrated Circuit) chip and peripheral IC components, can be connected to the panels through a COF (chip on flex) packaging method. The feature of the first embodiment of the present invention is to provide one ASIC chip 364 shared between the primary-display panel module 300M and the secondary-display panel module 300S. Thus, the ASIC chip 364 and the peripheral IC components are formed in relation to a connector that electrically connects the primary and secondary panels, therefore facilitating coupling the ASIC to the first and second display panels. The connector can be substantially flexible, such as a FPCB (flexible printed circuit board) 362. The two ends of the FPCB 362 are connected to the glass substrates of the first LCD panel 340 and the second LCD panel 350, respectively. The ASIC (Application Specific Integrated Circuit) is an IC product created in accordance with user-defined circuit design, which integrates multiple traditional-chip circuits on a chip to substantially reduce product defect rates. Currently, various kinds of ASIC chips have been developed, including an image/drafting chip, an LCD panel control chip, and an LCD display control chip.

The COF packaging method is a flip chip bonding method used on a FPCB, in which a nonconductive glue material without halogens and lead elements is provided on the FPCB, and then the cured state of the nonconductive glue material has a shrink stress that creates a connection between the IC chip and the electrode of the FPCB.

In dual-display panel modules, the ASIC chip 364 and the peripheral IC components are shared between the primary-display panel module 300M and the secondary-display panel module 300S through the FPCB 362, and then connected to a system board (not shown). The dual-display panel module has a shared ASIC chip 364, thus reducing power consumption, module cost, required area on the FPCB and components required thereby. Also, the original space required to dispose an ASIC chip and peripheral components for the secondary-display panel module 300S is effectively reduced.

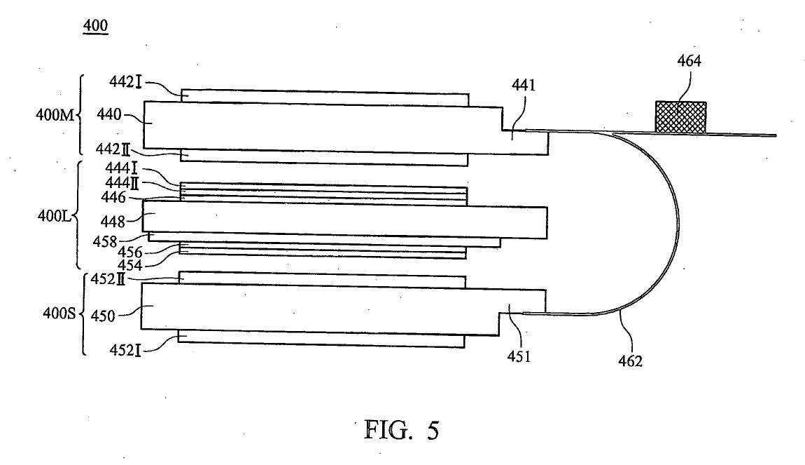

FIG. 5 is a cross-section of a dual-display panel module 400 according to the second embodiment of the present invention. The dual-display panel module 400 is used in a low-temperature polysilicon (LTPS) TFT-LCD device, in which a primary-display panel module 400M and a secondary-display panel module 400S have an identical display area. The dual-display panel module 400 shown in FIG. 4 is substantially similar to that of the dual-display panel module 300 shown in FIG. 3, thus the similar portions are omitted herein. The dissimilar portion is the integration mode of the driving chips. Since the electron conduction is faster in the LTPS TFT-LCD, a part of the driving chips is integrated into the interior of the glass substrate, which is favorable to reduce the required area and the amount of components on the PCB, and simplify the connecting wires between the driving chips and the panel electrodes. The feature of the second embodiment of the present invention is to provide one ASIC chip 464 shared between the primary-display panel module 400M and the secondary-display panel module 400S, thus reducing power consumption, module cost, the required area on the FPCB 462 and the required components on the FPCB 462. Also, the original space required to dispose an ASIC chip 464 and peripheral components for the secondary-display panel module 400S is effectively reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dual-display panel module, comprising:
a primary display module;
a secondary display module;
a connector electrically connecting the primary display module and secondary display module; and
a driver operatively coupled to the primary display module and secondary display module, wherein the driver is supported in electrical connections the primary display module and the secondary display modules via the connector.

2. The dual-display panel module of claim 1, wherein the connector is substantially flexible.

3. The dual-display panel module of claim 2, wherein the connector is a flexible printed circuit board.

4. The dual-display panel module of claim 1, wherein the driver is formed on the connector.

5. The dual-display panel module of claim 1, wherein the driver is an ASIC.

6. The dual-display panel module of claim 1, wherein at least one of the primary and secondary display panels comprises an amorphous silicon TFT-LCD panel.

7. The dual-display panel module of claim 1, wherein at least one of the primary and secondary display panels comprises a low temperature polysilicon TFT-LCD panel.

8. An electronic device, comprising:
a dual display module comprising:
a primary display module;
a secondary display module;
a connector electrically connecting the primary display module and secondary display module; and
a driver operatively coupled to the primary display module and secondary display module, wherein the driver is supported in electrical connections the primary display module and the secondary display modules via the connector; and
a controller operatively coupled to the dual display module and communicating display data to the dual display module.

9. The electronic device of claim 8, wherein the connector is substantially flexible.

10. The electronic device of claim 9, wherein the connector is a flexible printed circuit board.

11. The electronic device of claim 8, wherein the driver is formed on the connector.

12. The electronic device of claim 8, wherein the driver is an ASIC.

13. The electronic device of claim 8, wherein at least one of the primary and secondary display panels comprises an amorphous silicon TFT-LCD panel.

14. The electronic device of claim 8, wherein at least one of the primary and secondary display panels comprises a low temperature polysilicon TFT-LCD panel.
